(19) United States
(12) Patent Application Publication
(10) Pub. No.: US 2002/0022584 A1
(43) Pub. Date: Feb. 21, 2002

(54) Process for the production of sugar surfactant granules

(76) Inventors: Georg Assmann, Juechen (DE); Anke Becker, Dusseldorf (DE); Olaf Blockwitz, Genthin (DE); Karl-Heinz Petzold, Guesen (DE); Achim Peters, Genthin (DE)

Correspondence Address: Glenn E.J. Murphy, Esq., Henkel Corporation, Suite 200, 2500 Renaissance Boulevard, Gulph Mills, PA, 19406, US

(21) Appl. No.: 09/737,662

(22) Filed: Dec. 15, 2000

(30) Foreign Application Priority Data
Dec. 17, 1999 (DE) 199 61 333.8

(51) Int. Cl. C11D 17/06; C11D 17/00

(52) U.S. Cl. 510/470; 510/501; 510/502

(57) ABSTRACT

The invention relates to a process for the production of sugar surfactant granules in which water-containing sugar surfactant pastes are subjected to granulation in the presence of selected silicon compounds. In the production of such granules, caking problems are frequently encountered in the production units. A process for the production of sugar surfactant granules in which such problems are avoided has now been found. In this process, water-containing pastes of a) alkyl and/or alkenyl oligoglycosides and/or b) fatty acid-N-alkyl polyhydroxyalkyl amides are subjected to granulation in the presence of zeolites and/or waterglasses and optionally dried in a following process step, the granules being powdered with dusts during granulation.

A Process for the Production of Sugar Surfactant Granules This invention relates to a process for the production of sugar surfactant granules in which water-containing sugar surfactant pastes are subjected to granulation in the presence of selected silicon compounds.

Sugar surfactants, such as alkyl oligoglucosides or fatty acid-N-alkyl glucamides for example, are distinguished by excellent detergent properties and high ecotoxicological compatibility. For this reason, these classes of nonionic surfactants are acquiring increasing significance. Whereas the incorporation of these surfactants in liquid formulations, such as for example dishwashing detergents or hair shampoos, is routine, their incorporation in solid water-free formulations, for example in powder-form detergents, still involves difficulties.

In general, liquid surfactant formulations are industrially dried by conventional spray drying in which the water-containing surfactant paste is sprayed at the head of a tower in the form of fine droplets to which hot drying gases are passed in countercurrent. Unfortunately, this technology cannot readily be applied to sugar surfactant pastes because the temperatures required for drying are above the caramelization temperature, i.e. the decomposition temperature, of the sugar surfactants. In short, carbonized products are obtained in the conventional drying of sugar surfactant pastes, in addition to which caking occurs on the walls of the spray-drying tower and necessitates expensive cleaning at short intervals.

Attempts have been made in the past to overcome this problem. For example, German patent application DE-A1 41 02 745 (Henkel) describes a process in which a small quantity (1 to 5% by weight) of alkyl glucosides is added to fatty alcohol pastes which are then subjected to conventional spray drying. Unfortunately, the process can only be carried out in the presence of a large quantity of inorganic salts. According to German patent application DE-A1 41 39 551 (Henkel), pastes of alkyl sulfates and alkyl glucosides, which may only contain at most 50% by weight of the sugar surfactant, are sprayed in the presence of mixtures of soda and zeolites. However, this only gives compounds which have a low surfactant concentration and an inadequate bulk density. Finally, International patent application WO 95/14519 (Henkel) describes a process in which sugar surfactant pastes are subjected to drying with superheated steam. Unfortunately, this process is technically very complicated.

International patent application WO 97/03165 describes to a process for the production of sugar surfactant granules in which aqueous pastes of alkyl and/or alkenyl oligoglycosides and/or fatty acid-N-alkyl polyhydroxy-alkylamides are granulated in the presence of zeolites and/or waterglasses and optionally dried in a following process step. The use of the silicon compounds mentioned as support materials makes enables granules with a high bulk density of 500 to 1000 g/l and a sugar surfactant content of 30 to 90% by weight to be obtained. Even with a residual water content of up to 20% by weight, the granules are externally dust-dry so that there is no need for subsequent drying. They are free-flowing and stable in storage, do not show any tendency to form lumps and dissolve easily and substantially completely even in cold water. In addition, they show excellent colour quality. However, it has been found that, in the practical application of this process, caking problems arise in the granulator and affect the waste air filters in particular. Accordingly, the production process is still in need of improvement.

Accordingly, the problem addressed by the invention was to provide an improved process for the production of sugar surfactant granules which would have the advantages of the process described in WO 97/03165 and, in addition, would avoid problems attributable to caking of the products in the production unit.

It has surprisingly been found that this problem is solved by a process for the production of sugar surfactant granules in which water-containing pastes of a) alkyl and/or alkenyl oligoglycosides and/or b) fatty acid-N-alkyl polyhydroxyalkyl amides are subjected to granulation in the presence of zeolites and/or waterglasses and optionally dried in a following process step, characterized in that the granules are powdered with dusts during granulation.

The granules thus obtained have the advantages already known from WO 97/03165. They are free-flowing, stable in storage, have no tendency to form lumps and dissolve readily, even in cold water, with virtually no residue. In addition, they have excellent color quality. The process according to the invention also avoids the above-mentioned caking problems during granulation. Accordingly, this improved process provides for uninterrupted production of the granules; expensive stoppage times of the granulators for cleaning filters can thus be avoided.

Alkyl and/or alkenyl oligoglycosides in the context of the present invention are known nonionic surfactants which correspond to the formula R¹O-[G]ₚ in which R¹ is an alkyl and/or alkenyl group containing 4 to 22 carbon atoms, G is a sugar unit containing 5 or 6 carbon atoms and p is a number of 1 to 10. They may be obtained by the relevant methods of preparative organic chemistry. EP-A1-0 301 298 and WO 90/03977 are cited as representative of the extensive literature available on this subject.

The alkyl and/or alkenyl oligoglycosides may be derived from aldoses or ketoses containing 5 or 6 carbon atoms, preferably glucose. Accordingly, the preferred alkyl and/or alkenyl oligoglycosides are alkyl and/or alkenyl oligoglucosides.

The index p in the general formula indicates the degree of oligomerization (DP), i.e. the distribution of mono- and oligoglycosides, and is a number of 1 to 10. Whereas p in a given compound must always be an integer and, above all, may assume a value of 1 to 6, the value p for a certain alkyl oligoglycoside is an analytically determined calculated quantity which is generally a broken number. Alkyl and/or alkenyl oligoglycosides having an average degree of oligomerization p of 1.1 to 3.0 are preferably used. Alkyl and/or alkenyl oligoglycosides having a degree of oligomerization of less than 1.7 and, more particularly, between 1.2 and 1.4 are preferred from the applicational point of view.

The alkyl or alkenyl radical R¹ may be derived from primary alcohols containing 4 to 11 and preferably 8 to 10 carbon atoms. Typical examples are butanol, caproic alcohol, caprylic alcohol, capric alcohol and undecyl alcohol and the technical mixtures thereof obtained, for example, in the hydrogenation of technical fatty acid methyl esters or in the hydrogenation of aldehydes from Roelen's oxosynthesis. Alkyl oligoglucosides having a chain length of C₈ to C₁₀ (DP=1 to 3), which are obtained as first runnings in the separation of technical C₈₋₁₈ coconut oil fatty alcohol by distillation and which may contain less than 6% by weight of C₁₂ alcohol as an impurity, and also alkyl oligoglucosides based on technical C_{9/11} oxoalcohols (DP=1 to 3) are preferred.

In addition, the alkyl or alkenyl radical R¹ may also be derived from primary alcohols containing 12 to 22 and preferably 12 to 14 carbon atoms. Typical examples are lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol and technical mixtures thereof which may be obtained as described above. Alkyl oligoglucosides based on hydrogenated C_{12/14} coconut oil fatty alcohol having a DP of 1 to 3 are preferred.

Fatty acid N-alkyl polyhydroxyalkylamides in the context of the present invention are nonionic surfactants which correspond to the formula:

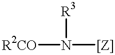

R²CO—N—[Z]

in which R²CO is an aliphatic acyl group containing 6 to 22 carbon atoms, R³ is hydrogen, an alkyl or hydroxyalkyl group containing 1 to 4 carbon atoms and [Z] is a linear or branched polyhydroxyalkyl group containing 3 to 12 carbon atoms and 3 to 10 hydroxyl groups.

The fatty acid-N-alkyl polyhydroxyalkylamides are known compounds which may normally be obtained by reductive amination of a reducing sugar with ammonia, an alkylamine or an alkanolamine and subsequent acylation with a fatty acid, a fatty acid alkyl ester or a fatty acid chloride. Processes for their production are described in U.S. Pat. No. 1,985,424, in U.S. Pat. No. 2,016,962 and in U.S. Pat. No. 2,703,798 and in International patent application WO 92/06984. An overview of this subject by H. Kelkenberg can be found in Tens. Surf. Det. 25, 8 (1988).

The fatty acid-N-alkyl polyhydroxyalkylamides are preferably derived from reducing sugars containing 5 or 6 carbon atoms, more particularly from glucose. Accordingly, the preferred fatty acid-N-alkyl polyhydroxyalkylamides are fatty acid N-alkyl glucamides which correspond to the formula:

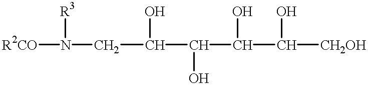

Preferred fatty acid-N-alkyl polyhydroxyalkylamides are glucamides in which R³ is hydrogen or an alkyl group and R²CO represents the acyl component of caproic acid, caprylic acid, capric acid, lauric acid, myristic acid, palmitic acid, palmitoleic acid, stearic acid, isostearic acid, oleic acid, elaidic acid, petroselic acid, linoleic acid, linolenic acid, arachic acid, gadoleic acid, behenic acid or erucic acid or technical mixtures thereof. Fatty acid-N-alkyl glucamides obtained by reductive amination of glucose with methylamine and subsequent acylation with lauric acid or C_{12/14} coconut oil fatty acid or a corresponding derivative are particularly preferred. In addition, the polyhydroxyalkylamides may also be derived from maltose and palatinose.

According to the invention, zeolites and/or waterglasses are used as carriers for these surfactants. According to the invention, zeolites are generally understood to be alumosilicates. Among the alumosilicates, crystalline alumosilicates—the zeolites—are preferably used. Zeolites preferred as carriers are the zeolites A, P, X, Y and mixtures thereof. The use of zeolite A as a carrier is known from numerous publications. However, zeolite P and faujasite zeolites have a higher oil absorption capacity than zeolite A and may therefore be preferred in granules. In one advantageous embodiment of the invention, at least part of the zeolite used, preferably at least 20% by weight and more preferably all the zeolite consists of faujasite zeolite. In the context of the present invention, the term “faujasite zeolite” characterizes all three zeolites which form the faujasite subgroup of zeolite structure group 4. According to the invention, therefore, zeolite Y and faujasite and mixtures of these compounds may be used besides zeolite X, pure zeolite X being preferred. The zeolite A-LSX described in European patent application EP-A-816 291, for example, may also be used with advantage in the process according to the invention. Zeolite A-LSX corresponds to a co-crystallizate of zeolite X and zeolite A and, in its water-free form, has the formula (M_{2/n}O+M═_{2/n}O)·Al₂O₃·zSiO₂, where M and M′ may be alkali and alkaline earth metals and z is a number of 2.1 to 2.6. This product is commercially obtainable under the name of VEGOBOND AX from CONDEA Augusta S.p.A. If zeolite P is used, it can be of advantage to use the zeolite MAP described in European patent EP-B-380 070. The particle sizes of the zeolites used in accordance with the invention are preferably in the range from 0.1 to 100 μm, more preferably in the range from 0.5 to 50 μm and most preferably in the range from 1 to 30 μm, as determined by standard methods for determining particle size.

The expression “waterglass” in the context of the invention is intended to encompass amorphous alkali metal silicates corresponding to the formula (SiO₂)ₘ(M²₂O)ₙ₁ and/or crystalline alkali metal silicates corresponding to the formula (SiO₂)ₘ(M²₂O)ₙ₂(H₂O)ₓ₂ in which M² is lithium, sodium or potassium, m and n1 are whole or broken numbers of>0, n2=1 and x2=0 or an integer of 1 to 20.

The amorphous alkali metal silicates are glass-like, water-soluble salts of silicic acid solidified from the melt. Their production is described, for example, in ROMPP, Chemie Lexikon, 9th Edition, Thieme Verlag, Stuttgart, Vol. 6, page 5003. Both alkali metal silicates with a low SiO₂ to M₂O ratio or m:n ratio (“basic” waterglasses) and alkali metal silicates with a high m:n ratio (“neutral” or “acidic” waterglasses) may be used for the process according to the invention. The SiO₂:M₂O ratio is also known as the “modulus” of the silicate. In addition, an overview can be found in Z. Chem. 28, 41 (1988).

The crystalline alkali metal silicates are also known substances. They have a layer-like structure and may be obtained, for example, by sintering alkali metal waterglass or by hydrothermal reactions [Glastechn. Ber., 37 194 (1964)]. Suitable crystalline alkali metal silicates are, for example, makatite (Na₂Si₄□5 H₂O), kenyaite (Na₂Si₂₂O₄₅□10 H₂O) or ilerite (Na₂Si₈O₁₇□9 H₂O) [Amer. Mineral. 38, 163 (1953)]. Waterglasses in which M is sodium and x=0 and of which the modulus, i.e. the m:n ratio, is from 1.9 to 4 and preferably from 1.9 to 2.5, have proved to be particularly suitable as carriers for the granulation process. The waterglasses may be used in the form of solids or even in the form of aqueous solutions with solids contents of 1 to 80% by weight and preferably 30 to 60% by weight, based on the silicate compound.

The granulation process may be carried out in any suitable granulator. However, the paste is preferably granulated by spray agglomeration and is preferably dried at the same time or in a subsequent step.

The granulation process may be carried out in any mixer/granulator suitable for spray agglomeration. However, it is preferably carried out in a fluidized bed operating continuously or in batches. In one particularly preferred embodiment, the process is carried out continuously in a fluidized bed, the liquid preparations being introduced into the fluidized bed through single- or multiple-bore nozzles or through several nozzles.

Production is carried out as described in European patent EP-B-603 207. According to the teaching of this patent, the surfactant preparation which contains a non-surfactant liquid component and which is present as a liquir or paste under normal pressure/20°-40° C. is granulated and at the same time dried. Advantages of this process for the production of free-flowing granules of different surfactant types include the avoidance of browning of the surfactants through careful drying and the absence of dust in the granules.

The carrier materials used are the carriers described above. The carrier component and other solids present, if any, are either introduced pneumatically through blow lines, in which case they are added either before or during spraying of the liquid components, or are added as a solution or suspension in the form of a mixture with the liquids, the liquid constituents being mixed either before spraying or in the nozzle itself. The nozzle or nozzles and their spraying direction may be arranged as required providing substantially uniform distribution of the liquid components in the fluidized bed is achieved.

Preferred fluidized bed granulators have base plates at least 0.4 m in diameter. Particularly preferred fluidized bed granulators have a base plate between 0.4 and 5 m in diameter, for example 1.2 m or 2.5 m in diameter. However, fluidized bed granulators having a base plate larger than 5 m in diameter are also suitable. The base plate may be a perforated plate or a Conidur plate (a product of Hein & Lehmann, Federal Republic of Germany). The process according to the invention is preferably carried out at fluidizing air flow rates of 1 to 8 m/s and, more particularly, 1.5 to 5.5 m/s.

According to the invention, the granules are advantageously discharged from the fluidized bed via a grading stage. Grading may be carried out, for example, using a sieve or by a stream of air flowing in countercurrent (grading air) which is controlled in such a way that only particles beyond a certain particle size are removed from the fluidized bed while smaller particles are retained therein. In one preferred embodiment, the air flowing in from below is made up of the heated or unheated grading air and the heated bottom air. The temperature of the bottom air is preferably between 80° and 400° C. and more preferably between 90° and 350° C. The fluidizing air cools down through heat losses and through the heat of evaporation of the constituents of the solvent. In one particularly preferred embodiment, the temperature of the fluidizing air about 5 cm above the base plate is between 60° and 120° C. and preferably between 70° and 100° C. The air exit temperature is preferably between 60° and 120° C. and more preferably below 100° C.

If the granules are discharged from the fluidized bed against a stream of grading air, as described in EP-B-0 603 207, dust-free granules are obtained, i.e. the granules preferably contain no particles larger than 0.2 mm. Preferred granules according to the invention have a d₅₀ value of 0.4 to 2.0 mm. In one particularly preferred embodiment, particles larger than 2.0 mm in size are recycled. This coarse fraction may either be added to the fluidized bed as a solid component after grinding or is redissolved and sprayed into the fluidized bed.

In addition, the fluidized bed granulator may contain the device for producing a rotation of air about the vertical axis of a fluidized bed which is described, for example, in earlier application DE 198 50 099.8 and which is designed in such a way that an air supply is located above the horizontal diffusor plate and comprises at least two air injection tubes which are arranged at a uniform distance from one another at the same height above the diffusor plate, being inclined at an angle of at least 30° and at most 90°. In a round fluidized bed granulator with an ascending outer flow, this device leads to a uniform distribution of temperature. In addition, particularly spherical granules can be produced in a correspondingly equipped fluidized bed granulator because the vertical flow in the external region of the fluidized bed has a higher flow rate than in the center of the fluidized bed and a fluidizing flow about the vertical axis of the fluidized bed can be produced through an air supply above the diffusor plate.

In the granulation process according to the invention, a dust is added as powdering agent during the granulation process. This dust may consist of various substances. According to the invention, the dust is preferably a fine-particle carrier material such as, for example, a fine-particle salt, preferably an alkali metal carbonate, or a silicate-containing carrier such as, for example, crystalline or amorphous silicates, more particularly overdried silicates or zeolite. In another preferred variant, a solid anionic surfactant is used as the dust. Alkyl sulfates, more particularly those of C₈₋₂₂ fatty alcohols, have proved to be particularly suitable. These powdering materials (“dusts”) are used in such quantities that they make up from 0.5 to 20% by weight and preferably from 2 to 10% by weight of the final granules, based on the total weight thereof.

The present invention also relates to detergents containing sugar surfactant granules of at least one type, the product of the process according to the invention, in addition to other constituents.

Besides the granules according to the invention, the detergents according to the invention, which may be present as granules, powder-form or tablet-form solids or other shaped bodies, may in principle contain any known ingredients typical of detergents. Preferred detergents according to the invention are granular detergents, more particularly those formed by mixing various granules of detergent components.

Key ingredients of the detergents according to the invention are, above all, anionic, nonionic, cationic, amphoteric and/or zwitterionic surfactants.

Suitable anionic surfactants are in particular soaps and those containing sulfate or sulfonate groups. Suitable surfactants of the sulfonate type are preferably C₉₋₁₃ alkyl benzenesulfonates, olefin sulfonates, i.e. mixtures of alkene and hydroxyalkane sulfonates, and the disulfonates obtained, for example, from C₁₂₋₁₈ monoolefins with an internal or terminal double bond by sulfonation with gaseous sulfur trioxide and subsequent alkaline or acidic hydrolysis of the sulfonation products. Other suitable surfactants of the sulfonate type are the alkane sulfonates obtained from C₁₂₋₁₈ alkanes, for example by sulfochlorination or sulfoxidation and subsequent hydrolysis or neutralization. The esters of α-sulfofatty acids (ester sulfonates), for example the α-sulfonated methyl esters of hydrogenated coconut oil, palm kernel oil or tallow fatty acids, which are obtained by a-sulfonation of the methyl esters of fatty acids of vegetable and/or animal origin containing 8 to 20 carbon atoms in the fatty acid molecule and subsequent neutralization to water-soluble monosalts are also suitable. The esters in question are preferably the α-sulfonated esters of hydrogenated coconut oil, palm oil, palm kernel oil or tallow fatty acid, although sulfonation products of unsaturated fatty acids, for example oleic acid, may also be present in small quantities, preferably in quantities of not more than about 2 to 3% by weight. α-Sulfofatty acid alkyl esters with an alkyl chain of not more than 4 carbon atoms in the ester group, for example methyl esters, ethyl esters, propyl esters and butyl esters, are particularly preferred. The methyl esters of α-sulfofatty acids (MES) and saponified disalts thereof are used with particular advantage.

Other suitable anionic surfactants are sulfonated fatty acid glycerol esters, i.e. the monoesters, diesters and triesters and mixtures thereof which are obtained where production is carried out by esterification of a monoglycerol with 1 to 3 moles of fatty acid or in the transesterification of triglycerides with 0.3 to 2 moles of glycerol.

Preferred alk(en)yl sulfates are the alkali metal salts and, in particular, the sodium salts of the sulfuric acid semiesters of C12-18 fatty alcohols, for example cocofatty alcohol, tallow fatty alcohol, lauryl, myristyl, cetyl or stearyl alcohol, or C₁₀₋₂₀ oxoalcohols and the corresponding semiesters of secondary alcohols with the same chain length. Other preferred alk(en)yl sulfates are those with the chain length mentioned which contain a synthetic, linear alkyl chain based on a petrochemical and which are similar in their degradation behavior to the corresponding compounds based on oleochemical raw materials. C₁₂₋₁₆ alkyl sulfates and C₁₂₋₁₅ alkyl sulfates and also C₁₄₋₁₅ alkyl sulfates are particularly preferred from the washing performance point of view. Other suitable anionic surfactants are 2,3-alkyl sulfates which may be produced, for example, in accordance with U.S. Pat. No. 3,234,258 or U.S. Pat. No. 5,075,041 and which are commercially obtainable as products of the Shell Oil Company under the name of DAN®.

The sulfuric acid monoesters of linear or branched C₇₋₂₁ alcohols ethoxylated with 1 to 6 moles of ethylene oxide, such as 2-methyl-branched C₉₋₁₁ alcohols containing on average 3.5 moles of ethylene oxide (EO) or C₁₂₋₁₈ fatty alcohols containing 1 to 4 EO, are also suitable. In view of their high foaming capacity, they are normally used in only relatively small quantities, for example in quantities of 1 to 5% by weight, in detergents.

Other preferred anionic surfactants are the salts of alkyl sulfosuccinic acid which are also known as sulfosuccinates or as sulfosuccinic acid esters and which represent monoesters and/or diesters of sulfosuccinic acid with alcohols, preferably fatty alcohols and, more particularly, ethoxylated fatty alcohols. Preferred sulfosuccinates contain C₈₋₁₈ fatty alcohol molecules or mixtures thereof. Particularly preferred sulfosuccinates contain a fatty alcohol molecule derived from ethoxylated fatty alcohols which, considered in isolation, represent nonionic surfactants. Of these sulfosuccinates, those of which the fatty alcohol molecules are derived from narrow-range ethoxylated fatty alcohols are particularly preferred. Alk(en)yl succinic acid preferably containing 8 to 18 carbon atoms in the alk(en)yl chain or salts thereof may also be used.

Other suitable anionic surfactants are fatty acid derivatives of amino acids, for example of N-methyl taurine (taurides) and/or of N-methyl glycine (sarcosides). The sarcosides or rather sarcosinates, above all sarcosinates of higher and optionally mono- or poly-unsaturated fatty acids, such as oleyl sarcosinate, are particularly preferred.

Other suitable anionic surfactants are, in particular, soaps which are used, for example, in quantities of 0.2 to 5% by weight. Suitable soaps are, in particular, saturated fatty acid soaps, such as the salts of lauric acid, myristic acid, palmitic acid, stearic acid, hydrogenated erucic acid and behenic acid, and soap mixtures derived in particular from natural fatty acids, for example coconut oil, palm kernel oil or tallow fatty acids.

The anionic surfactants, including the soaps, may be present in the form of their sodium, potassium or ammonium salts and as soluble salts of organic bases, such as mono-, di- or triethanolamine. The anionic surfactants are preferably present in the form of their sodium or potassium salts and, more preferably, in the form of their sodium salts. Anionic surfactants are present in detergents according to the invention in quantities of preferably 1% by weight to 35% by weight and, more preferably, 5% by weight to 30% by weight.

Preferred nonionic surfactants are alkoxylated, advantageously ethoxylated, more particularly primary alcohols preferably containing 8 to 18 carbon atoms and an average of 1 to 12 moles of ethylene oxide (EO) per mole of alcohol, in which the alcohol residue may be linear or, preferably, 2-methyl-branched or may contain linear and methyl-branched residues in the form of the mixtures typically present in oxoalcohols. However, alcohol ethoxylates containing linear residues of alcohols of native origin with 12 to 18 carbon atoms, for example coconut oil, palm oil, tallow fatty alcohol or oleyl alcohol, and an average of 2 to 8 EO per mole of alcohol are particularly preferred. Preferred ethoxylated alcohols include, for example, C₁₂₋₁₄ alcohols containing 3 EO or 4 EO, C₉₋₁₁ alcohols containing 7 EO, C₁₃₋₁₅ alcohols containing 3 EO, 5 EO, 7 EO or 8 EO, C₁₂₋₁₈ alcohols containing 3 EO, 5 EO or 7 EO and mixtures thereof, such as mixtures of C₁₂₋₁₄ alcohol containing 3 EO and C₁₂₋₁₈ alcohol containing 7 EO. The degrees of ethoxylation mentioned are statistical mean values which, for a special product, may be either a whole number or a broken number. Preferred alcohol ethoxylates have a narrow homolog distribution (narrow range ethoxylates, NRE). In addition to these nonionic surfactants, fatty alcohols containing more than 12 EO may also be used, as described above. Examples of such fatty alcohols are (tallow) fatty alcohols containing 14 EO, 16EO, 20EO, 25 EO, 30 EO or 40 EO.

Another class of preferred nonionic surfactants are alkoxylated, preferably ethoxylated or ethoxylated and propoxylated, fatty acid alkyl esters preferably containing 1 to 4 carbon atoms in the alkyl chain, more particularly the fatty acid methyl esters which are described, for example, in Japanese patent application JP 58/217598 or which are preferably produced by the process described in International patent application WO-A-90/13533.

Nonionic surfactants of the amine oxide type, for example N-cocoalkyl-N,N-dimethylamine oxide and N-tallowalkyl-N,N-dihydroxyethyl amine oxide, and the fatty acid alkanolamide type are also suitable. The quantity in which these nonionic surfactants are used is preferably no more, in particular no more than half, the quantity of ethoxylated fatty alcohols used. According to the invention, the nonionic surfactants are preferably used in the form of the granules according to the invention although, as in another preferred embodiment, only part or only certain nonionic surfactants is/are introduced into the detergent through the granules according to the invention.

Other suitable surfactants are so-called gemini surfactants. Gemini surfactants are generally understood to be compounds which contain two hydrophilic groups per molecule. These groups are generally separated from one another by a so-called “spacer”. The spacer is generally a carbon chain which should be long enough for the hydrophilic groups to have a sufficient spacing to be able to act independently of one another. Gemini surfactants are generally distinguished by an unusually low critical micelle concentration and by an ability to reduce the surface tension of water to a considerable extent. In exceptional cases, however, gemini surfactants are not only understood to be “dimeric” surfactants, but also “trimeric” surfactants. Suitable gemini surfactants are, for example, sulfated hydroxy mixed ethers and dimer alcohol bis- and trimer alcohol tris-sulfates and -ether sulfates. End-capped dimeric and trimeric mixed ethers are distinguished in particular by their bifunctionality and multifunctionality. Thus, the end-capped surfactants mentioned exhibit good wetting properties and are low-foaming so that they are particularly suitable for use in machine washing or cleaning processes. However, gemini polyhydroxyfatty acid amides or poly-polyhydroxyfatty acid amides may also be used.

The detergents according to the invention additionally contain a builder system consisting of at least one organic and/or inorganic builder.

Useful organic builders are, for example, polycarboxylic acids usable in the form of their sodium salts, polycarboxylic acids in this context being those carboxylic acids which carry more than one acid function. These include, for example, citric acid, adipic acid, succinic acid, glutaric acid, malic acid, tartaric acid, maleic acid, fumaric acid, sugar acids, amino-carboxylic acids, nitrilotriacetic acid (NTA)—providing its use is not ecologically unsafe—and mixtures thereof. Preferred salts are the salts of the polycarboxylic acids, such as citric acid, adipic acid, succinic acid, glutaric acid, tartaric acid, sugar acids and mixtures thereof.

The acids per se may also be used. Besides their builder effect, the acids also typically have the property of an acidifying component and, hence, also serve to establish a relatively low and mild pH value in detergents/cleaners. Citric acid, succinic acid, glutaric acid, adipic acid, gluconic acid and mixtures thereof are particularly mentioned in this regard.

Other suitable builders are polymeric polycarboxylates such as, for example, the alkali metal salts of polyacrylic or polymethacrylic acid, for example those with a relative molecular weight of 500 to 70,000 g/mole.

The molecular weights mentioned in this specification for polymeric polycarboxylates are weight-average molecular weights M_{w} of the particular acid form which, basically, were determined by gel permeation chromatography (GPC) using a UV detector. The measurement was carried out against an external polyacrylic acid standard which provides realistic molecular weight values by virtue of its structural similarity to the polymers investigated. These values differ distinctly from the molecular weights measured against polystyrene sulfonic acids as standard. The molecular weights measured against polystyrene sulfonic acids are generally higher than the molecular weights mentioned in this specification.

Particularly suitable polymers are polyacrylates which preferably have a molecular weight of 2,000 to 20,000 g/mole. By virtue of their superior solubility, preferred representatives of this group are the short-chain polyacrylates which have molecular weights of 2,000 to 10,000 g/mole and, more particularly, 3,000 to 5,000 g/mole.

Also suitable are copolymeric polycarboxylates, particularly those of acrylic acid with methacrylic acid and those of acrylic acid or methacrylic acid with maleic acid. Acrylic acid/maleic acid copolymers containing 50 to 90% by weight of acrylic acid and 50 to 10% by weight of maleic acid have proved to be particularly suitable. Their relative molecular weights, based on the free acids, are generally in the range from 2,000 to 70,000 g/mole, preferably in the range from 20,000 to 50,000 g/mole and more preferably in the range from 30,000 to 40,000 g/mole.

The (co)polymeric polycarboxylates may be used either in the form of an aqueous solution or in powder form. The detergents preferably contain 0.5 to 20% by weight and more particularly 3 to 10% by weight of (co)polymeric polycarboxylates.

In order to improve solubility in water, the polymers may also contain allyl sulfonic acids, such as for example allyloxybenzene sulfonic acid and methallyl sulfonic acid, as monomer.

Other particularly preferred polymers are biodegradable polymers of more than two different monomer units, for example those which contain salts of acrylic acid and maleic acid and vinyl alcohol or vinyl alcohol derivatives as monomers or those which contain salts of acrylic acid and 2-alkylallyl sulfonic acid and sugar derivatives as monomers.

Other preferred copolymers are those which are described in German patent applications DE-A-43 03 320 and DE-A-44 17 734 and which preferably contain acrolein and acrylic acid/acrylic acid salts or acrolein and vinyl acetate as monomers.

Other preferred builders are polymeric aminodicarboxylic acids, salts or precursors thereof. Particular preference is attributed to polyaspartic acids or salts and derivatives thereof which, according to German patent application DE-A-195 40 086, are also said to have a bleach-stabilizing effect in addition to their co-builder properties.

Other suitable builders are polyacetals which may be obtained by reaction of dialdehydes with polyol carboxylic acids containing 5 to 7 carbon atoms and at least three hydroxyl groups. Preferred polyacetals are obtained from dialdehydes, such as glyoxal, glutaraldehyde, terephthalaldehyde and mixtures thereof and from polyol carboxylic acids, such as gluconic acid and/or glucoheptonic acid.

Other suitable organic builders are dextrins, for example oligomers or polymers of carbohydrates which may be obtained by partial hydrolysis of starches. The hydrolysis may be carried out by standard methods, for example acid- or enzyme-catalyzed methods. The end products are preferably hydrolysis products with average molecular weights of 400 to 500,000 g/mole. A polysaccharide with a dextrose equivalent (DE) of 0.5 to 40 and, more particularly, 2 to 30 is preferred, the DE being an accepted measure of the reducing effect of a polysaccharide by comparison with dextrose which has a DE of 100. Both maltodextrins with a DE of 3 to 20 and dry glucose sirups with a DE of 20 to 37 and also so-called yellow dextrins and white dextrins with relatively high molecular weights of 2,000 to 30,000 g/mole may be used.

The oxidized derivatives of such dextrins are their reaction products with oxidizing agents which are capable of oxidizing at least one alcohol function of the saccharide ring to the carboxylic acid function. Dextrins thus oxidized and processes for their production are known from numerous publications. An oxidized oligosaccharide corresponding to German patent application DE-A-196 00 018 is also suitable. A product oxidized at C₆ of the saccharide ring can be particularly advantageous.

Other suitable co-builders are oxydisuccinates and other derivatives of disuccinates, preferably ethylenediamine disuccinate. Ethylenediamine-N,N′-disuccinate (EDDS) is preferably used in the form of its sodium or magnesium salts. Glycerol disuccinates and glycerol trisuccinates are also particularly preferred in this connection. The quantities used in zeolite-containing and/or silicate-containing formulations are from 3 to 15% by weight.

Other useful organic co-builders are, for example, acetylated hydroxycarboxylic acids and salts thereof which may optionally be present in lactone form and which contain at least 4 carbon atoms, at least one hydroxy group and at most two acid groups. Co-builders such as these are described, for example, in International patent application WO 95/20029.

Another class of substances with co-builder properties are the phosphonates, more particularly hydroxyalkane and aminoalkane phosphonates. Among the hydroxyalkane phosphonates, 1-hydroxyethane-1,1-diphosphonate (HEDP) is particularly important as a co-builder. It is preferably used in the form of a sodium salt, the disodium salt showing a neutral reaction and the tetrasodium salt an alkaline reaction (pH 9). Preferred aminoalkane phosphonates are ethylenediamine tetramethylene phosphonate (EDTMP), diethylenetriamine pentamethylene phosphonate (DTPMP) and higher homologs thereof. They are preferably used in the form of the neutrally reacting sodium salts, for example as the hexasodium salt of EDTMP and as the hepta- and octasodium salt of DTPMP. Within the class of phosphonates, HEDP is preferably used as builder. The aminoalkane phosphonates also show a pronounced heavy metal binding capacity. Accordingly, it can be of advantage to use aminoalkane phosphonates, more especially DTPMP, or mixtures of the phosphonates mentioned.

In addition, any compounds capable of complexing alkaline earth metal ions may be used as co-builders.

A preferred inorganic builder is finely crystalline, synthetic zeolite containing bound water, preferably zeolite A, X and/or P. However, mixtures of A, X and/or P are also suitable. A particularly preferred zeolite P is, for example, zeolite MAP (for example Doucil A24, a product of Crosfield). A co-crystallized sodium/potassium-aluminium silicate of zeolite A and zeolite X, which is marketed, for example, under the name of VEGOBOND AX® (by Condea Augusta S.p.A.), is also of particular interest. The zeolite may be used as a spray-dried powder or even as an undried stabilized suspension still moist from its production. Where the zeolite is used in the form of a suspension, the suspension may contain small additions of nonionic surfactants as stabilizers, for example 1 to 3% by weight, based on zeolite, of ethoxylated C₁₂₋₁₈ fatty alcohols containing 2 to 5 ethylene oxide groups, C₁₂₋₁₄ fatty alcohols containing 4 to 5 ethylene oxide groups or ethoxylated isotridecanols. Suitable zeolites have a mean particle size of less than 10 μm (volume distribution, as measured by the Coulter Counter method) and contain preferably 10 to 22% by weight and, more preferably, 15 to 22% by weight of bound water.

Suitable substitutes or partial substitutes for the zeolite are layer silicates of natural and synthetic origin. Their suitability is not confined to a particular composition or structural formula, although smectites and especially bentonites are preferred. Crystalline layer-form sodium silicates corresponding to the general formula NaMSiₓO₂ₓ₊₁□yH₂O, where M is sodium or hydrogen, x is a number of 1.9 to 4 and y is a number of 0 to 20, preferred values for x being 2, 3 or 4, are also suitable substitutes for zeolites and phosphates. Crystalline layer silicates such as these are described, for example, in European patent application EP-A-0 164 514. Preferred crystalline layer silicates corresponding to the above formula are those in which M is sodium and x assumes the value 2 or 3. Both β- and δ-sodium disilicates Na₂Si₂O₅□yH₂O are particularly preferred.

Other preferred builders are amorphous sodium silicates with a modulus (Na₂O:SiO₂ ratio) of 1:2 to 1:3.3, preferably 1:2 to 1:2.8 and more preferably 1:2 to 1:2.6 which dissolve with delay and exhibit multiple wash cycle properties. The delay in dissolution in relation to conventional amorphous sodium silicates can have been obtained in various ways, for example by surface treatment, compounding, compacting or by overdrying. In the context of the invention, the term “amorphous” is also understood to encompass “X-ray amorphous”. In other words, the silicates do not produce any of the sharp X-ray reflexes typical of crystalline substances in X-ray diffraction experiments, but at best one or more maxima of the scattered X-radiation which have a width of several degrees of the diffraction angle. Particularly good builder properties may even be achieved where the silicate particles produce crooked or even sharp diffraction maxima in electron diffraction experiments. This may be interpreted to mean that the products have microcrystalline regions between 10 and a few hundred nm in size, values of up to at most 50 nm and, more particularly, up to at most 20 nm being preferred. So-called X-ray amorphous silicates such as these, which also dissolve with delay in relation to conventional waterglasses, are described for example in German patent application DE-A-44 00 024. Compacted amorphous silicates, compounded amorphous silicates and overdried X-ray-amorphous silicates are particularly preferred.

The generally known phosphates may of course also be used as builders providing their use is not ecologically problematical. The sodium salts of orthophosphates, pyrophosphates and, in particular, tripolyphosphates are particularly suitable. Their content is generally no more than 25% by weight and preferably no more than 20% by weight, based on the final detergent. In some cases, it has been found that tripolyphosphates in particular, even in small quantities of up to at most 10% by weight, based on the final detergent, produce a synergistic improvement in multiple wash cycle performance in combination with other builders.

Among the compounds yielding H₂O₂ in water which serve as bleaching agents, sodium perborate monohydrate or tetrahydrate and sodium percarbonate are particularly important. Other useful bleaching agents are, for example, peroxypyrophosphates, citrate perhydrates and H₂O₂-yielding peracidic salts or peracids, such as perbenzoates, peroxophthalates, diperazelaic acid, phthaloiminoperacid or diperdodecane dioic acid. The content of bleaching agents in the detergents is from 0 to 30% by weight and more particularly from 5 to 25% by weight, perborate monohydrate or percarbonate advantageously being used.

In order to obtain an improved bleaching effect where washing is carried out at temperatures of 60° C. or lower, bleach activators may be incorporated. The bleach activators may be compounds which form aliphatic peroxocarboxylic acids containing preferably 1 to 10 carbon atoms and more preferably 2 to 4 carbon atoms and/or optionally substituted perbenzoic acid under perhydrolysis conditions. Substances bearing O-and/or N-acyl groups with the number of carbon atoms mentioned and/or optionally substituted benzoyl groups are suitable. Preferred bleach activators are polyacylated alkylenediamines, more particularly tetraacetyl ethylenediamine (TAED), acylated triazine derivatives, more particularly 1,5-diacetyl-2,4-dioxohexahydro-1,3,5-triazine (DADHT), acylated glycolurils, more particularly tetraacetyl glycoluril (TAGU), N-acylimides, more particularly N-nonanoyl succinimide (NOSI), acylated phenol sulfonates, more particularly n-nonanoyl or isononanoyloxybenzenesulfonate (n- or iso-NOBS), carboxylic anhydrides, more particularly phthalic anhydride, acylated polyhydric alcohols, more particularly triacetin, ethylene glycol diacetate and 2,5-diacetoxy-2,5-dihydrofuran.

In addition to or instead of the conventional bleach activators mentioned above, so-called bleach catalysts may also be incorporated in the tablets. Bleach catalysts are bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and cobalt-, iron-, copper- and ruthenium-ammine complexes may also be used as bleach catalysts.

Suitable enzymes are those from the class of proteases, lipases, amylases, cellulases or mixtures thereof. Enzymes obtained from bacterial strains or fungi, such as Bacillus subtilis, Bacillus licheniformis and Streptomyces griseus, are particularly suitable. Proteases of the subtilisin type are preferred, proteases obtained from Bacillus lentus being particularly preferred. Enzyme mixtures, for example of protease and amylase or protease and lipase or protease and cellulase or of cellulase and lipase or of protease, amylase and lipase or of protease, lipase and cellulase, but especially cellulase-containing mixtures, are of particular interest. Peroxidases or oxidases have also proved to be suitable in some cases. The enzymes may be adsorbed to supports and/or encapsulated in membrane materials to protect them against premature decomposition.

In addition, components with a positive effect on the removability of oil and fats from textiles by washing (so-called soil repellents) may also be used. This effect becomes particularly clear when a textile which has already been repeatedly washed with a detergent according to the invention containing this oil- and fat-dissolving component is soiled. Preferred oil- and fat-dissolving components include, for example, nonionic cellulose ethers, such as methyl cellulose and methyl hydroxypropyl cellulose containing 15 to 30% by weight of methoxyl groups and I to 15% by weight of hydroxypropoxyl groups, based on the nonionic cellulose ether, and the polymers of phthalic acid and/or terephthalic acid known from the prior art or derivatives thereof, more particularly polymers of ethylene terephthalates and/or polyethylene glycol terephthalates or anionically and/or nonionically modified derivatives thereof. Of these, the sulfonated derivatives of phthalic acid and terephthalic acid polymers are particularly preferred.

The detergents may contain derivatives of diamino-stilbenedisulfonic acid or alkali metal salts thereof as optical brighteners. Suitable optical brighteners are, for example, salts of 4,4′-bis-(2-anilino-4-morpholino-1,3,5-triazinyl-6-amino)-stilbene-2,2′-disulfonic acid or compounds of similar composition which contain a diethanolamino group, a methylamino group, an anilino group or a 2-methoxyethylamino group instead of the morpholino group. Brighteners of the substituted diphenyl styryl type, for example alkali metal salts of 4,4′-bis-(2-sulfostyryl)-diphenyl, 4,4′-bis-(4-chloro-3-sulfostyryl)-diphenyl or 4-(4-chlorostyryl)-4′-(2-sulfostyryl)-diphenyl, may also be present. Mixtures of the brighteners mentioned above may also be used.

Dyes and perfumes are added to detergents to improve the aesthetic impression created by the products and to provide the consumer not only with the required washing performance but also with a visually and sensorially “typical and unmistakable” product. Suitable perfume oils or perfumes include individual perfume compounds, for example synthetic products of the ester, ether, aldehyde, ketone, alcohol and hydrocarbon type. Perfume compounds of the ester type are, for example, benzyl acetate, phenoxyethyl isobutyrate, p-tert.butyl cyclohexyl acetate, linalyl acetate, dimethyl benzyl carbinyl acetate, phenyl ethyl acetate, linalyl benzoate, benzyl formate, ethyl methyl phenyl glycinate, allyl cyclohexyl propionate, styrallyl propionate and benzyl salicylate. The ethers include, for example, benzyl ethyl ether; the aldehydes include, for example, the linear alkanals containing 8 to 18 carbon atoms, citral, citronellal, citronellyloxyacetaldehyde, cyclamen aldehyde, hydroxycitronellal, lilial and bourgeonal; the ketones include, for example, the ionones, α-isomethyl ionone and methyl cedryl ketone; the alcohols include anethol, citronellol, eugenol, geraniol, linalool, phenyl ethyl alcohol and terpineol and the hydrocarbons include, above all, the terpenes, such as limonene and pinene. However, mixtures of various perfumes which together produce an attractive perfume note are preferably used. Perfume oils such as these may also contain natural perfume mixtures obtainable from vegetable sources, for example pine, citrus, jasmine, patchouli, rose or ylang-ylang oil. Also suitable are clary oil, camomile oil, clove oil, melissa oil, mint oil, cinnamon leaf oil, lime blossom oil, juniper berry oil, vetiver oil, olibanum oil, galbanum oil and labdanum oil and orange blossom oil, neroli oil, orange peel oil and sandalwood oil. Detergents normally contain less than 0.01% by weight of dyes whereas perfumes/fragrances can make up as much as 2% by weight of the formulation as a whole.

The perfumes may be directly incorporated in the detergents although it can also be of advantage to apply the perfumes to supports which strengthen the adherence of the perfume to the washing and which provide the textiles with a long-lasting fragrance through a slower release of the perfume. Suitable support materials are, for example, cyclodextrins, the cyclodextrin/perfume complexes optionally being coated with other auxiliaries.

In order to improve their aesthetic impression, detergents may be colored with suitable dyes. Preferred dyes, which are not difficult for the expert to choose, have high stability in storage, are not affected by the other ingredients of the detergents or by light and do not have any pronounced substantivity for textile fibers so as not to color them.

The bulk density of the advantageously granular detergents is preferably at least about 600 g/l and more particularly in the range from 650 to 1100 g/l. However, detergents with a lower bulk density can also be produced. In one particularly preferred embodiment, the detergents are built from granular individual components on the lines of a building block system.

The invention is illustrated by the following Examples.

### EXAMPLES

The production of granules with composition V in a fluidized bed granulator (under the conditions described in patent application WO 97/03165) was repeatedly disrupted by the occurrence of caking in the granulator and particularly on the filters.

Granules with the composition B could be produced without disruption under the same conditions after the process had been modified to include the continuous addition of fatty alcohol sulfate dust during granulation.

| | V | B |
|---|---|---|
| APG [% by weight] | 50 | 50 |
| Sodium silicate [% by weight] | 14 | 14 |
| Sodium sulfate [% by weight] | 32 | 27 |
| Water [% by weight] | 4 | 4 |
| FAS [% by weight] | — | 5 |

APG: alkyl polyglucoside (APG 600 ®, Cognis)
Sodium silicate: soda waterglass, modulus 2.4
FAS: fatty alkyl sulfate (Sulfopon 1218G ®, Cognis)

The granules B produced in accordance with the invention flowed freely and did not stick together in storage.

1. A process for the production of sugar surfactant granules in which water-containing pastes of
a) alkyl and/or alkenyl oligoglycosides and/or
b) fatty acid-N-alkyl polyhydroxyalkyl amides are subjected to granulation in the presence of zeolites and/or waterglasses and optionally dried in a following process step, characterized in that the granules are powdered with dusts during granulation.

2. A process as claimed in claim 1, characterized in that alkyl and alkenyl oligoglycosides corresponding to the formula R¹O—[G]ₚ, in which R¹ is an alkyl and/or alkenyl group containing 4 to 22 carbon atoms, G is a sugar unit containing 5 or 6 carbon atoms and p is a number of 1 to 10, are used.

3. A process as claimed in claims 1 and 2, characterized in that fatty acid-N-alkyl polyhydroxyalkylamides corresponding to the formula: 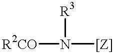
in which R²CO is an aliphatic acyl group containing 6 to 22 carbon atoms, R³ is hydrogen, an alkyl or hydroxyalkyl group containing 1 to 4 carbon atoms and [z] is a linear or branched polyhydroxyalkyl group containing 3 to 12 carbon atoms and 3 to 10 hydroxyl groups, are used:

4. A process as claimed in claims 1 to 3, characterized in that the fatty acid-N-alkyl polyhydroxyalkylamides are preferably fatty acid-N-alkyl glucamides which correspond to the formula: 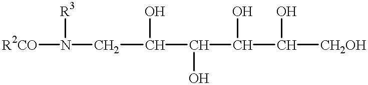
in which R³ is hydrogen or an alkyl group and R²CO represents the acyl component of caproic acid, caprylic acid, capric acid, lauric acid, myristic acid, palmitic acid, palmitoleic acid, stearic acid, isostearic acid, oleic acid, elaidic acid, petroselic acid, linoleic acid, linolenic acid, arachic acid, gadoleic acid, behenic acid or erucic acid or technical mixtures thereof, fatty acid-N-alkyl glucamides obtained by reductive amination of glucose with methylamine and subsequent acylation with lauric acid or C_{12/14} coconut oil fatty acid or a corresponding derivative being particularly preferred.

5. A process as claimed in claims 1 to 4, characterized in that waterglasses with the formulae (SiO₂)ₘ(M²₂O)ₙ₁ and/or (SiO₂)ₘ(M²₂O)ₙ₂(H₂O)ₓ₂, in which M is lithium, sodium or potassium, m and n1 are whole or broken numbers of>0, n2=1 and x2=0 or an integer of 1 to 20, are used.

6. A process as claimed in claims 1 to 5, characterized in that granulation is carried out in a mixer.

7. A process as claimed in claims 1 to 5, characterized in that granulation in carried out in a fluidized bed granulator.

8. A process as claimed in claims 1 to 7, characterized in that the dusts consist of one or more substances selected from the group consisting of fine-particle carriers, such as fine-particle salts, preferably alkali metal carbonate, or silicate-based carriers such as, for example, crystalline or amorphous silicates, more particularly overdried silicates or zeolites, and solid anionic surfactants, more particularly the alkyl sulfates, preferably those of C₈₋₂₂ fatty alcohols.

9. A process as claimed in claims 1 to 7, characterized in that the dusts are used in such quantities that they make up from 0.5 to 20% by weight and preferably from 2 to 10% by weight of the final granules, based on the total weight thereof.

10. A detergent, characterized in that it contains the sugar surfactant granules produced by the process claimed in any of claims 1 to 9.
